(19) United States
(12) Patent Application Publication
(10) Pub. No.: US 2015/0144612 A1
(43) Pub. Date: May 28, 2015

(54) ELECTRIC THERMOS WITH MANUAL TIMER SWITCH

(71) Applicants: FU-CHI WU, NORTHRIDGE, CA (US); STEVEN WU, LOS ANGELES, CA (US)

(72) Inventors: FU-CHI WU, NORTHRIDGE, CA (US); STEVEN WU, LOS ANGELES, CA (US)

(21) Appl. No.: 14/088,630

(22) Filed: Nov. 25, 2013

(51) Int. Cl. H05B 1/02; E03B 9/20; A47J 41/00

(52) U.S. Cl. CPC H05B 1/0225; A47J 41/005; E03B 9/20
USPC 219/441

(57) ABSTRACT

An electric thermos having a manual timer switch installed in a control panel at the top side of the electric thermos body thereof and electrically connected to the heating circuit and operable to set the time to turn on/off the electric heating circuit and the duration of the heating time of the electric heating circuit, saving electric energy consumption.

### BACKGROUND OF THE INVENTION

1. Field of the Invention

The present invention relates to electric thermos technology, and more particularly, to an electric thermos having a manual timer switch operable to set the time to turn on/off the electric heating circuit and the duration of the heating time of the electric heating circuit, saving electric energy consumption.

2. Description of the Related Art

Conventional drinking fountains are commonly equipped with an automatic power switch that automatically switches off power supply when heating water reaches a predetermined temperature level. However, in order to automatically heat water and to keep water warm, conventional electric thermoses do not have a power switch, and therefore, the use of conventional electric thermoses consume much electric energy. Further, the warm-keeping functions of commercial electric thermos are still not perfect. During the warm-keeping mode, the electric thermos body is kept at a certain high temperature level, releasing heat to the indoor space by radiation. When an air conditioner is operating to lower the indoor temperature in the summer, the air conditioner shall have to consume extra electric energy to offset the hot temperature released by the electric thermos, and thus, must electric energy is wasted. Further, when wishing to stop an electric thermos from heating or running the warm-keeping function, the user has to disconnect the power plug from either the power outlet or the electric thermos. Frequently plugging and unplugging the power cable of an electric thermos can cause power plug damage, or accidental electrical shock.

Further, conventional electric thermoses commonly provide a LCD control panel for operation by a user to control the heating time. However, due to the problems of small font and low brightness of the LCD control panel, an aged person may be difficult to operate the LCD control panel. Further, it can be easy to forget how to control the LCD control panel. Thus, not every member of a family likes to use the LCD control panel of the electric thermos. Further, manual control mode for controlling the heating time is most intuitive and most easy to use. Each time using the manual control mode, the power supply can be turned off imperatively at the predetermined time point, saving electric energy consumption.

### SUMMARY OF THE INVENTION

The present invention has been accomplished under the circumstances in view. It is one object of the present invention to provide an electric thermos, which allows manual operation to set the time to turn on/off the electric heating circuit and the duration of the heating time of the electric heating circuit, saving electric energy consumption.

It is another object of the present invention to provide an electric thermos, which provides a manual timer switch operable to set the time to turn on/off the electric heating circuit and the duration of the heating time of the electric heating circuit.

To achieve these and other objects of the present invention, an electric thermos of the present invention comprises a manual timer switch installed in the control panel at the top side of the electric thermos body thereof and electrically connected to the heating circuit and operable to set the time to turn on/off the electric heating circuit and the duration of the heating time of the electric heating circuit, saving electric energy consumption.

Further, the manual timer switch can be a manual 24-hour cycle multi-stage control timer switch.

Further, manual timer switch or manual 24-hour cycle multi-stage control timer switch can also be used in a drinking fountain to achieve the same effects.

### BRIEF DESCRIPTION OF THE DRAWINGS

FIG. 1 is an oblique top elevational view of an electric thermos equipped with a manual timer switch in accordance with the present invention.

FIG. 2 is an enlarged view of a part of FIG. 1.

FIG. 3 is similar to FIG. 1, illustrating the manual timer switch installed in the periphery of the electric thermos body of the electric thermos.

FIG. 4 is an oblique top elevational view of a hot and cold water fountain equipped with a manual timer switch in accordance with the present invention.

FIG. 5 is an oblique top elevational view of an electric thermos equipped with a manual 24-hour cycle multi-stage control timer switch in accordance with the present invention.

FIG. 6 is an enlarged view of a part of FIG. 5.

FIG. 7 is similar to FIG. 6, illustrating the manual 24-hour cycle multi-stage control timer switch installed in the periphery of the electric thermos body of the electric thermos.

FIG. 8 is an oblique top elevational view of a hot and cold water fountain equipped with a manual 24-hour cycle multi-stage control timer switch in accordance with the present invention.

### DETAILED DESCRIPTION OF THE PREFERRED EMBODIMENT

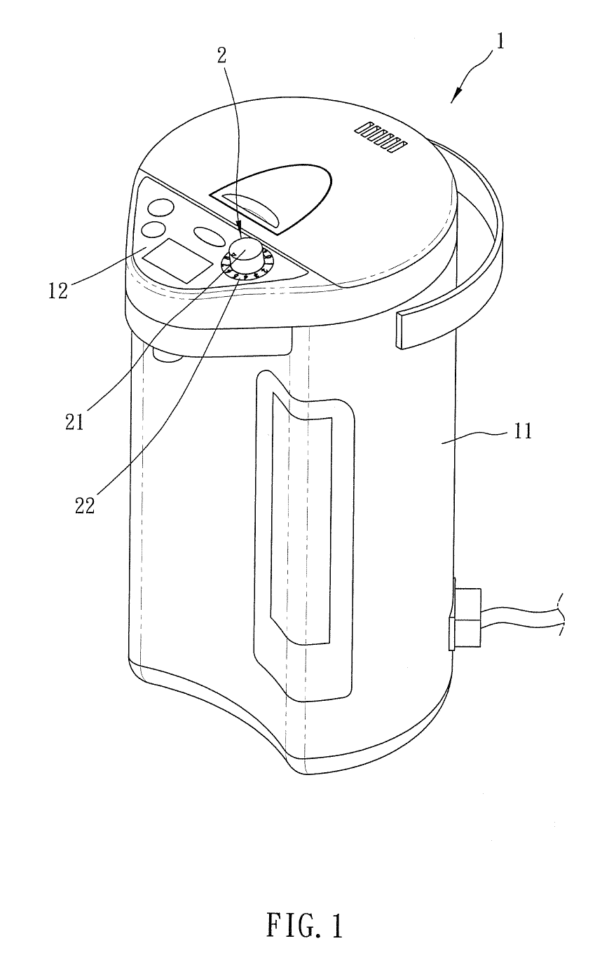

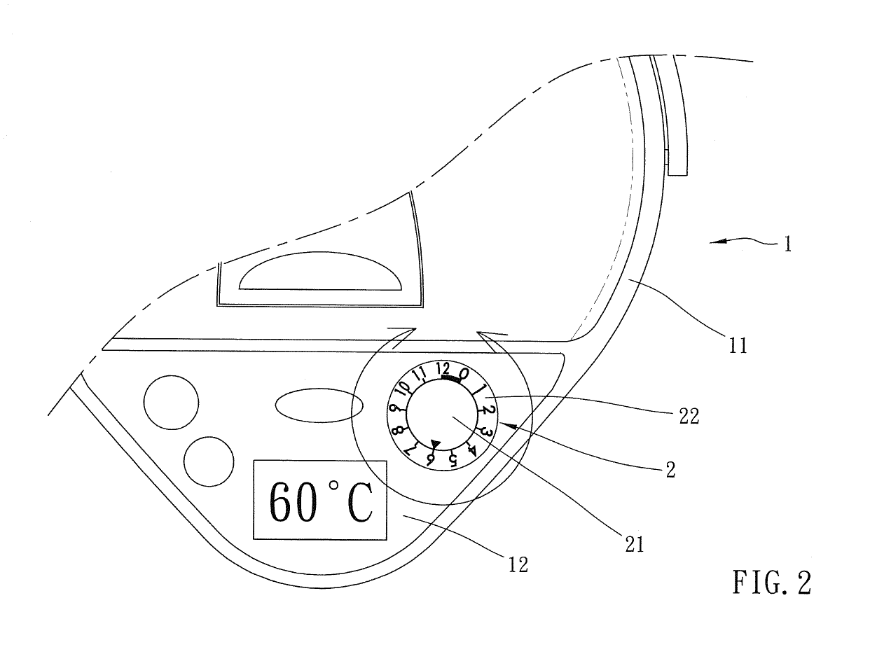

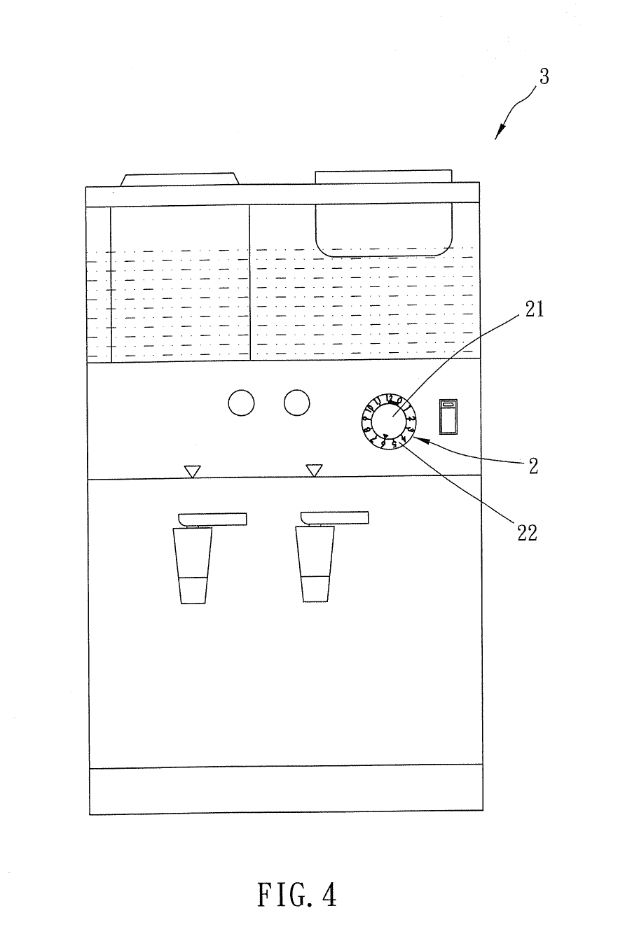

Referring to FIGS. 1 and 2, a manual timer switch 2 is installed in a control panel 12 at a top side of an electric thermos body 11 of an electric thermos 1 for adjusting the heating time. The manual timer switch 2 comprises an adjustment knob 21 and a time scale 22. Through the adjustment knob 21 and the time scale 22, the user can set the time to turn on/off the electric heating circuit of the electric thermos 1 and the duration of the heating time of the electric heating circuit of the electric thermos 1. In the hot summer, the manual timer switch 2 can be set to turn off the electric thermos 1 at a proper time, saving power consumption and reducing the generation of hot steam. The manual timer switch 2 can also be used in a hot and cold water fountain 3 (see FIG. 4). The functioning of the manual timer switch 2 in the electric thermos 1 or hot and cold water fountain 3 prevents the situation of constant operation of the heating or cooling circuit of the electric thermos 1 or hot and cold water fountain 3, thereby saving power consumption.

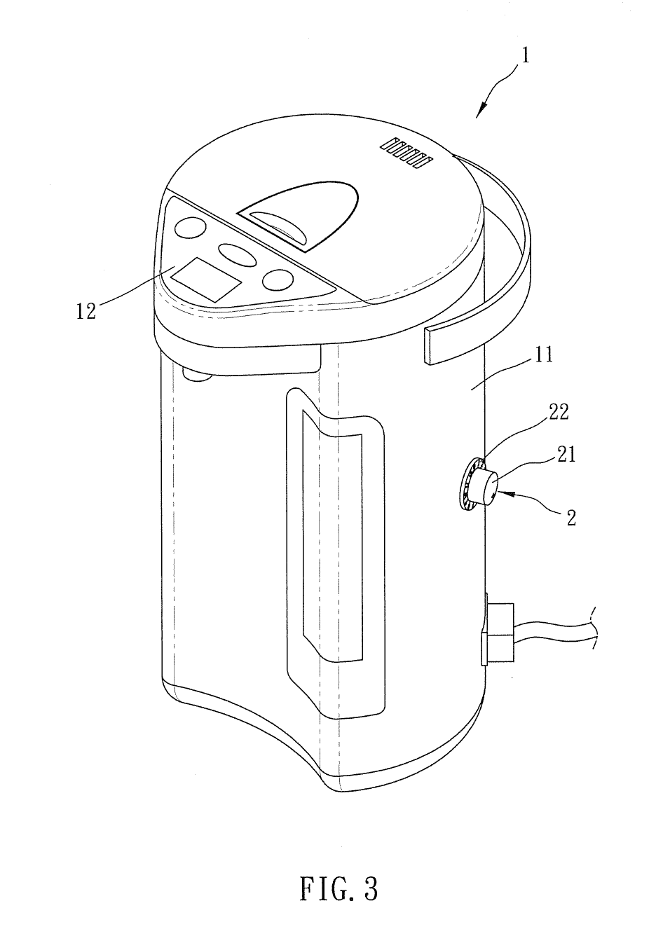

Further, the manual timer switch 2 can also be installed in the peripheral wall of then electric thermos body 11 of the electric thermos 1 (see FIG. 3).

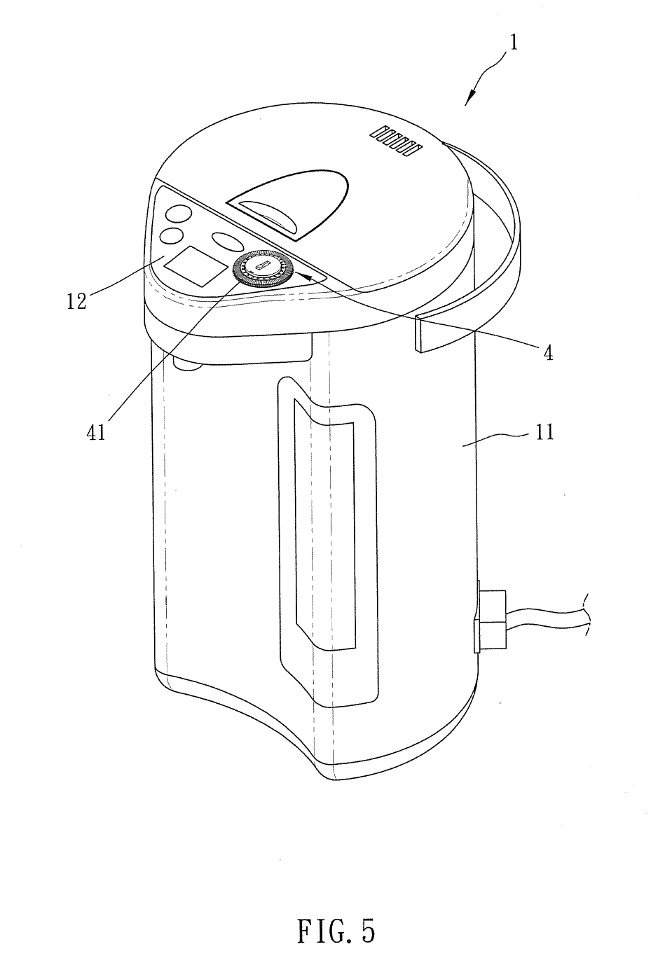

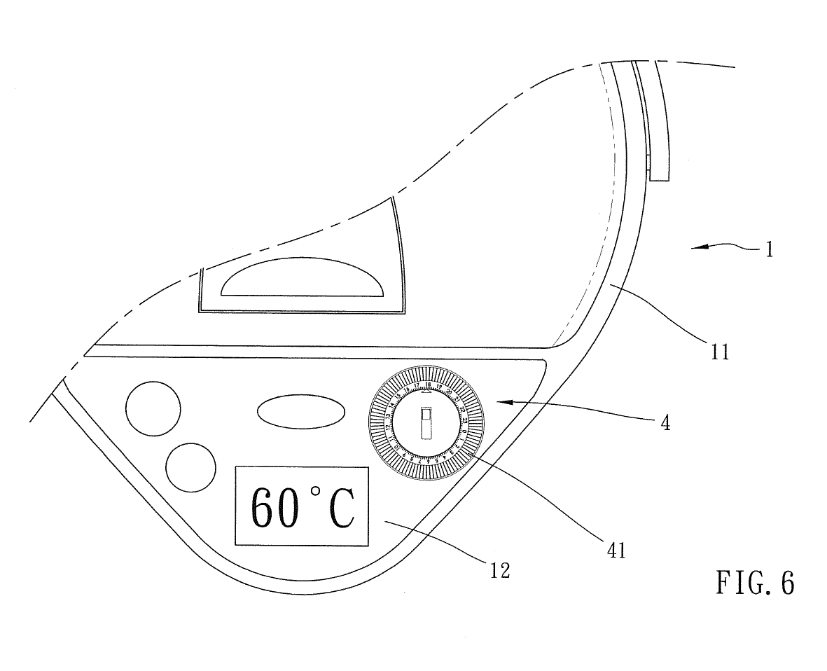

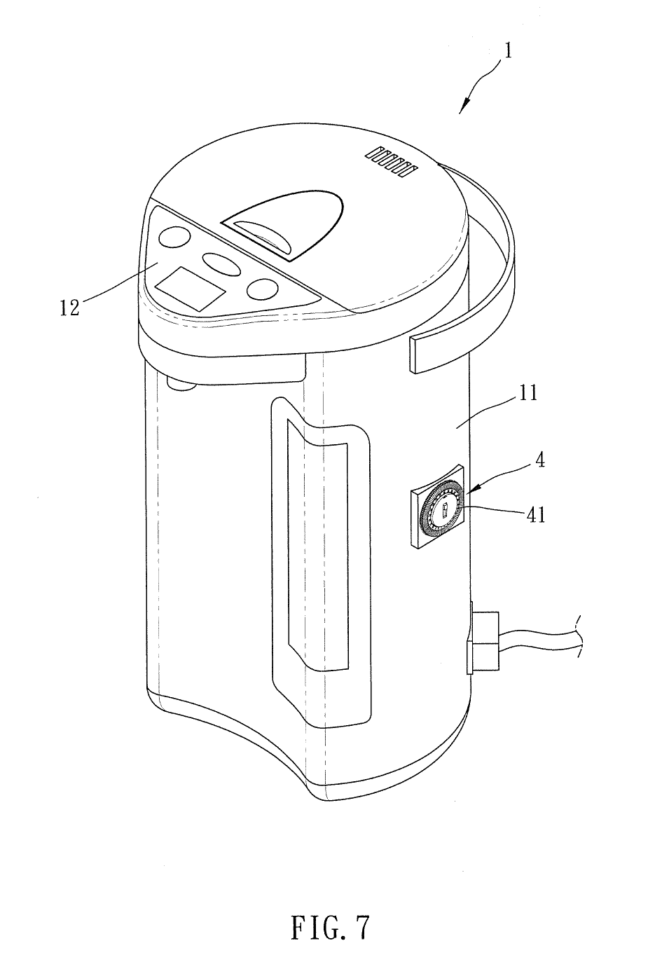

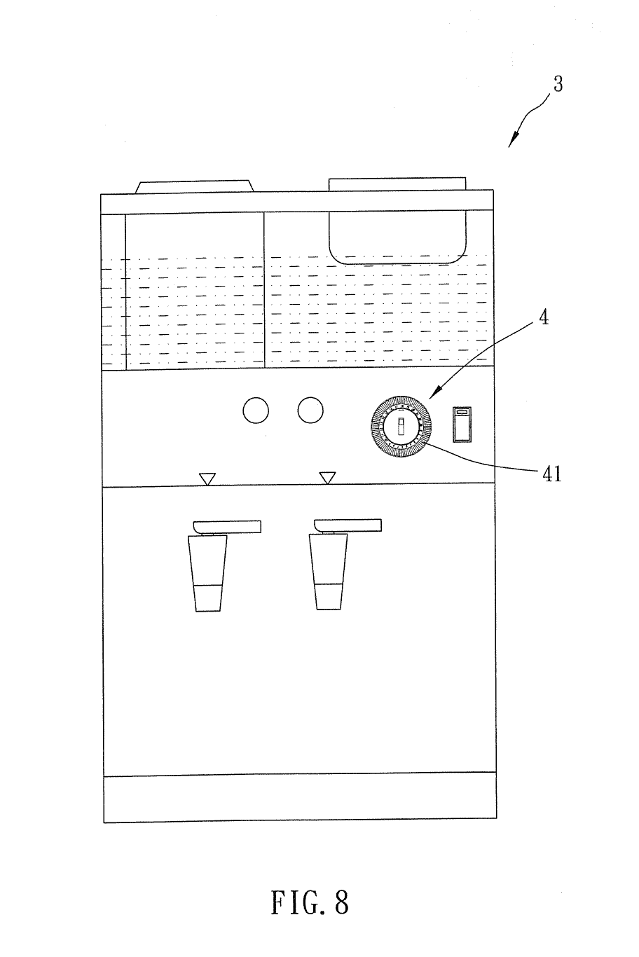

In an alternate form of the present invention, as shown in FIGS. 5-8, a manual 24-hour cycle multi-stage control timer switch 4 is installed in a control panel 12 at a top side of an electric thermos body 11 of an electric thermos 1 or the peripheral wall of the electric thermos body 11 of the electric thermos 1, or a hot and cold water fountain 3. The manual 24-hour cycle multi-stage control timer switch 4 comprises a dial 41. A user can operate the dial 41 of the manual 24-hour cycle multi-stage control timer switch 4, setting the time to turn on/off the electric heating circuit of the electric thermos 1 or hot and cold water fountain 3 and the duration of the heating time of the electric heating circuit of the electric thermos 1 or hot and cold water fountain 3.

In summary, the invention provides an electric thermos/hot and cold water fountain equipped with a manual timer switch or manual 24-hour cycle multi-stage control timer switch that is adapted for setting the time to turn on/off the electric heating circuit of the electric thermos or hot and cold water fountain and the duration of the heating time of the electric heating circuit of the electric thermos or hot and cold water fountain.

The functioning of the manual timer switch or manual 24-hour cycle multi-stage control timer switch in the electric thermos or hot and cold water fountain prevents the situation of constant operation of the heating or cooling circuit of the electric thermos or hot and cold water fountain, thereby saving electric energy consumption.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An electric thermos, comprising a manual timer switch installed in an electric thermos body thereof and electrically connected to a heating circuit thereof, said manual timer switch comprising an adjustment knob and a time scale, and operable to set the time to turn on/off said electric heating circuit of the electric thermos and the duration of the heating time of said electric heating circuit.

2. The electric thermos as claimed in claim 1, which is installed in a drinking fountain.

3. The electric thermos as claimed in claim 1, wherein said manual timer switch is installed in a control panel at a top side of said electric thermos body.

4. The electric thermos as claimed in claim 1, wherein said manual timer switch is a manual 24-hour cycle multi-stage control timer switch.
